(19) United States
(12) Patent Application Publication
(10) Pub. No.: US 2022/0174955 A1
(43) Pub. Date: Jun. 9, 2022

(54) Composition for a Plant Growth Additive

(71) Applicant: Lance Niemann, Prescott Valley, AZ (US)

(72) Inventor: Lance Niemann, Prescott Valley, AZ (US)

(21) Appl. No.: 17/542,126

(22) Filed: Dec. 3, 2021

Related U.S. Application Data
(60) Provisional application No. 63/121,072, filed on Dec. 3, 2020.

(51) Int. Cl. A01N 43/78; C05D 1/00; A01N 43/90; A01N 43/08; A01N 37/02

(52) U.S. Cl. CPC A01N 43/78; C05D 1/00; A01N 37/02; A01N 43/08; A01N 43/90

(57) ABSTRACT

A composition for a plant growth additive that stimulates growth and promotes maximum nutrient absorption. The composition includes a quantity of vitamin B1, a quantity of vitamin B2, a quantity of vitamin C, a quantity of citric acid, a quantity of boron, a quantity of molybdenum, a quantity of potassium, and a quantity of hydrated silica that are homogeneously mixed into a growth-stimulant composition. The composition may be mixed with at least one supplemental growth ingredient such as a quantity of beeswax extract. In order to for the growth-stimulant composition to be safer when applied to a plant, a nutrient solution may further include a quantity of solute and a quantity of solvent, with the growth-stimulant composition as the quantity of solute and a quantity of water as the quantity of solvent. The composition may further be mixed with at least one macro-nutrient ingredient and at least one pH-adjusting ingredient.

The current application claims a priority to the U.S. Provisional Patent application Ser. No. 63/121,072 filed on Dec. 3, 2020.

### FIELD OF THE INVENTION

The present invention generally relates to a composition for a plant growth additive. More specifically, the present invention stimulates biological growth.

### BACKGROUND OF THE INVENTION

Plant growth additives or nutrients are almost always used to facilitate the primary metabolism of a plant. Primary metabolites are compounds that are directly involved in the growth and development of a plant. Secondary metabolites, which in the Cannabis plant include terpenes and cannabinoids, are useful for medicinal purposes and give plants their color and other hormone-driven characteristics.

Plant growth, specifically of Cannabis, is critical to creating plants of extreme health and trichome development for use in medicine. Cannabis is the only known dioecious (distinctly male or female) annual plant, an unusual characteristic that allows it to be modified to grow in virtually any environment. Based on its unusual botany, its closest mechanical relative is hops, and it is a perennial.

Most important, Cannabis is the only plant that produces significant levels of chemicals that react with the human endocannabinoid system. Medicinal use of plant-derived cannabinoids through the C. sativa or C. indica genetic strains is well documented. The Cannabis plant's cannabinoids are neuroprotective and anti-inflammatory agents useful in treating Alzheimer's disease, Parkinson's disease, dementia, Crohn's disease, seizures, strokes, spinal trauma, and cancer. Patients who are prescribed medical Cannabis are often already sick and physically compromised, so it is vitally important that they receive Cannabis in as pure a form as possible, uncontaminated by pesticides, mold, mycotoxins, or other residues.

Most states now require rigorous testing of Cannabis that is difficult to pass when using many current growth additives. For example, more than 60 pesticides are currently tested for, along with four mycotoxins and heavy metals. Current laws require that Cannabis be grown in the state where it is sold. Many states' climates preclude outdoor Cannabis cultivation, so that growers must cultivate the plant indoors, under lights. In some climates, growers can use greenhouses; in others, outdoor growth is possible.

Regardless, a safe and easy-to-use product would be useful for all growing climates and methods.

It is therefore an objective of the present invention to promote the growth and health of the Cannabis plant. The present invention provides a means to promote growth and health of secondary metabolites. Moreover, the present invention offers an indefinite shelf life in comparison to existing additives due to the stability of the combination of ingredients.

### BRIEF DESCRIPTION OF THE DRAWINGS

FIG. 1 is a block diagram showing a growth-stimulant composition.

FIG. 2 is a block diagram showing the growth-stimulant composition with a quantity of beeswax extract.

FIG. 3 is a block diagram showing the growth-stimulant composition with a second quantity of vitamin B1.

FIG. 4 is a block diagram showing the growth-stimulant composition with a second quantity of vitamin B2.

FIG. 5 is a block diagram showing the growth-stimulant composition with a second quantity of vitamin C.

FIG. 6 is a block diagram showing the growth-stimulant composition with a second quantity of citric acid.

FIG. 7 is a block diagram showing a nutrient solution.

FIG. 8 is a block diagram showing at least one macro-nutrient ingredient.

FIG. 9 is a block diagram showing the growth-stimulant composition the at least one macro-nutrient ingredient.

FIG. 10 is a block diagram showing at least one pH-adjusting ingredient.

FIG. 11 is a block diagram showing the growth-stimulant composition the at least one pH-adjusting ingredient.

### DETAIL DESCRIPTIONS OF THE INVENTION

All illustrations of the drawings are for the purpose of describing selected versions of the present invention and are not intended to limit the scope of the present invention.

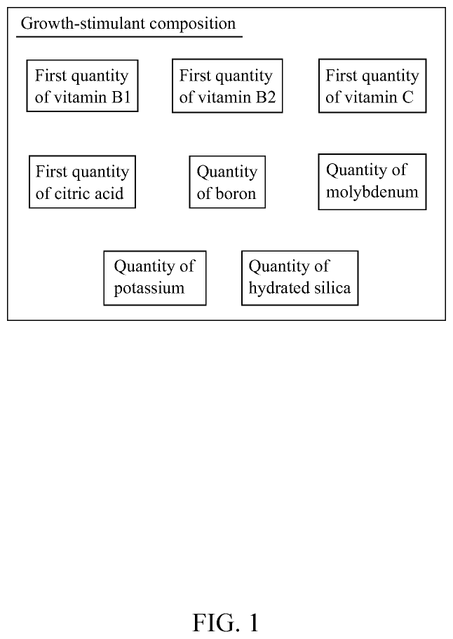

The present invention is a composition for a plant growth additive that aids seed inoculation and germination, vegetative growth, and flower phase growth. The present invention promotes plant growth to maximize the health of the plant as well as the production of terpenes, other secondary metabolites, and cannabinoids. Moreover, plant development is regulated by complex interactions that are controlled by exposure to light, water, and nutrients. Furthermore, plant development is important in indoor growth environments that characterize much of Cannabis production. In order for the present invention to target growth factors that maximizes secondary metabolism, the present invention comprises a first quantity of vitamin B1, a first quantity of vitamin B2, a first quantity of vitamin C, a first quantity of citric acid, a quantity of boron, a quantity of molybdenum, a quantity of potassium, and a quantity of hydrated silica, seen in FIG. 1. The quantity of boron and the quantity of molybdenum are micronutrients. More specifically, the quantity of boron stimulates production of plant fibers and aids the transport of other nutrients throughout the plant, aiding both the xylem and the phloem. The quantity of molybdenum transports nitrogen through the xylem and the phloem. The quantity of potassium is essential for all plant activities involving water transportation and all stages of plant growth, which is especially important for Cannabis buds. Furthermore, the quantity of potassium increases disease resistance and promotes water respiration and photosynthesis. The quantity of hydrated silica aids in the overall plant growth under various growth conditions. Moreover, the quantity of hydrated silica that is transferred to the plant tissue builds the xylem and the phloem, thus strengthening the entire plant against environmental stresses. And the quantity of hydrated silica the is transferred to leaf tissue makes the leaves more resistant to mold, such as powdery mildew, and to penetration by predatory pests. Furthermore, the quantity of hydrated silica improves leaf directness, promoting photosynthesis.

The first quantity of vitamin B1, the first quantity of vitamin B2, the first quantity of vitamin C, the first quantity of citric acid, the quantity of boron, the quantity of molybdenum, the quantity of potassium, and the quantity of hydrated silica are homogenously mixed into a growth-stimulant composition, also seen in FIG. 1. The growth-stimulant composition produces a large number of specialized compounds that boost levels of terpenes and cannabinoids. The large number of specialized compounds is essential for coping with abiotic stresses such as increased UV radiation, heat, humidity, pathogens, and pests. Moreover, the growth-stimulant composition increases vascular pressure, improving absorption and annual utilization of nutrients, increases the number of nodes and density of trichomes on a female flower, boosts terpene content, and increases cannabinoid concentration.

In order to optimize potential growth of the structure of the plant, the flowers of the plant, and the resulting secondary metabolites, such as terpenes and cannabinoids, the aforementioned compositional components are mixed at specific preferred ratios. Thus, the first quantity of vitamin B1 is approximately 0.5 to 2 percentage by weight (wt. %) of the growth-stimulant composition. Furthermore, the first quantity of vitamin B2 is approximately 0.1 to 2 wt. % of the growth-stimulant composition. Furthermore, the quantity of vitamin C is approximately 0.5 to 4 wt. % of the growth-stimulant composition. Furthermore, the first quantity of citric acid is approximately 0.1 to 4 wt. % of the growth-stimulant composition. Furthermore, the quantity of boron is approximately 0.001 to 0.3 wt. % of the growth-stimulant composition. Furthermore, the quantity of molybdenum is approximately 0.0001 to 0.02 wt. % of the growth-stimulant composition. Furthermore, the quantity of potassium is approximately 0.1 to 3 wt. % of the growth-stimulant composition. Furthermore, the quantity of hydrated silica is approximately 0.2 to 5 wt. % of the growth-stimulant composition.

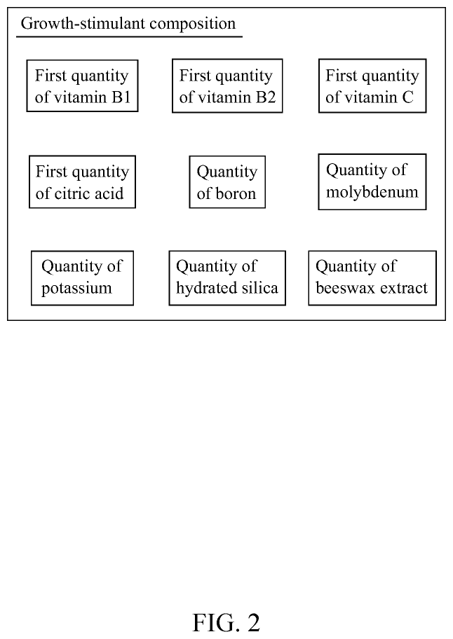

The present invention may further comprise a quantity of beeswax extract, seen in FIG. 2. The quantity of beeswax extract promotes growth during the flower phase of a plant similar to that of trichome development. The quantity of beeswax extract is further heterogeneously mixed into the growth-stimulant composition. Moreover, the quantity of beeswax extract is approximately between 0.1 to 3 wt. % of the growth-stimulant composition.

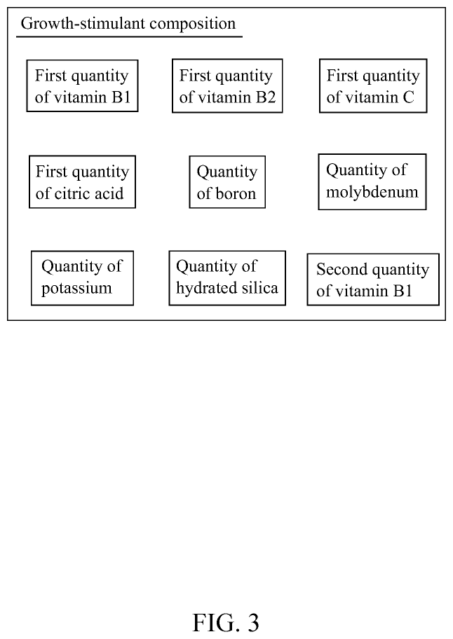

The present invention may further comprise a second quantity of vitamin B1, seen in FIG. 3. The second quantity of B1 stimulates hormones that increase systemic acquired resistance (SAR) response in plants. Plants with higher SAR response are much more resistant to abiotic stresses such as heat and drought, as well as to pathogens and pests. The second quantity of vitamin B1 is heterogeneously mixed into the growth-stimulant composition. Moreover, the second quantity of vitamin B1 is approximately 0.5 to 2 wt. % of the growth-stimulant composition.

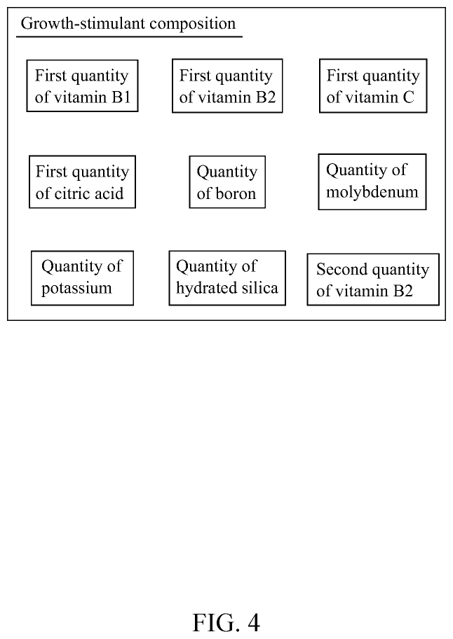

The present invention may further comprise a second quantity of vitamin B2, seen in FIG. 4. The second quantity of vitamin B2 reduces the energy requirements for growth and increases the SAR response of a plant, thereby boosting resistance to abiotic stresses such as heat and drought. The second quantity of vitamin B2 is heterogeneous mixed into the growth-stimulant composition. Moreover, the second quantity of vitamin B2 is approximately 0.1 to 1 wt. % of the growth-stimulant composition.

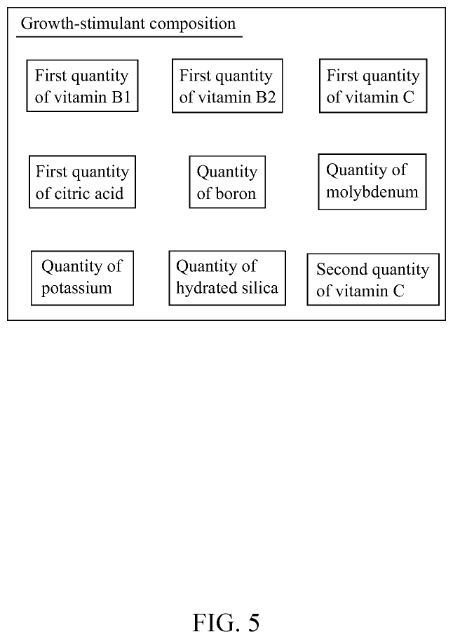

The present invention may further comprise a second quantity of vitamin C, seen in FIG. 5. The second quantity of vitamin C notably increases mitosis, and consequently growth, as well as secondary metabolites. Moreover, the second quantity of vitamin C serves as an antifeedant such that the ability to feed or reproduce of a pest is significantly reduced. The second quantity of vitamin C is heterogeneously mixed into the growth-stimulant composition. Moreover, the second quantity of vitamin C is approximately 0.227 to 4 wt. % of the growth-stimulant composition. In the preferred embodiment of the present invention, the second quantity of vitamin C is 0.5 wt. % of the growth-stimulant composition.

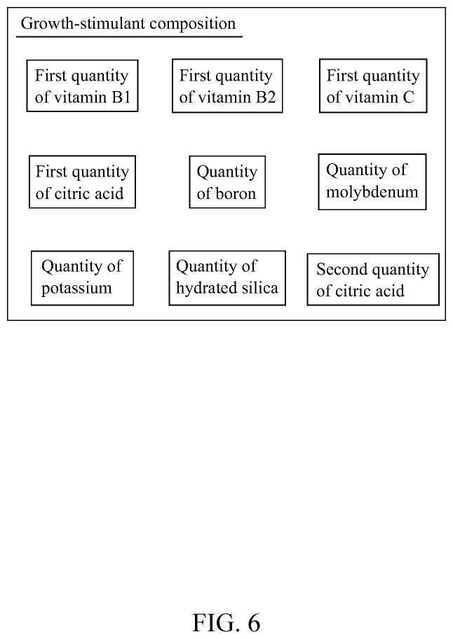

The present invention may further comprise a second quantity of citric acid, seen in FIG. 6. The second quantity of citric acid increases plant growth during the Krebs cycle, which can take place without light or environmental carbon dioxide during “dark cycle growth.” The second quantity of citric acid also penetrates the skin of small harmful insects that breathe through an exoskeleton instead of through the lungs, thereby unbalancing bodily fluids and causing death by suffocation. The second quantity of citric acid is heterogeneously mixed into the growth-stimulant composition. Moreover, the second quantity of citric acid is approximately between 0.2 to 5 wt. % of the growth-stimulant composition. In the preferred embodiment of the present invention, the second quantity of citric acid is 1 to 2 wt. % of the growth-stimulant composition.

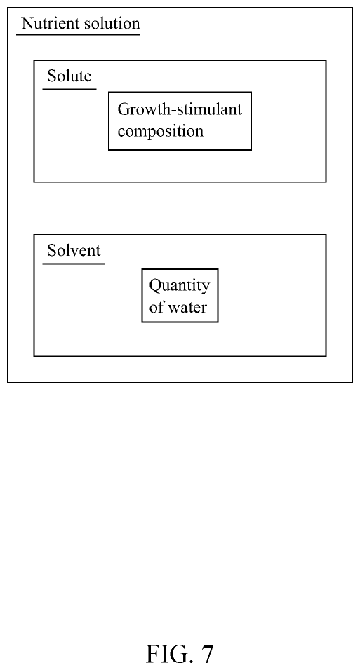

In order to apply the growth-stimulant composition to a plant, a nutrient solution comprises a quantity of solute and a quantity of solvent, seen in FIG. 7. The quantity of solute targets secondary metabolites in order to increase the quality and quantity of medicinal production for cannabinoids and terpenes. The quantity of solvent makes the quantity of solute safer for the plant while deterring pests such as spiders, mites, whiteflies, thrips, and so on. The quantity of solute is the growth-stimulant composition, and the quantity of solvent is a quantity of water. For the seed/cutting phase of a plant, the quantity of solute is approximately between 0.26 to 0.79 wt. % of the quantity of nutrient solution. For the vegetative phase and the flower phase of a plant, the quantity of solute is approximately between 0.79 to 4 wt. % of the quantity of nutrient solution. For a foliar spray, the quantity of solute is approximately between 2.6 to 5.3 wt. % of the quantity of nutrient solution. The foliar spray may be applied to a plant immediately in order to increase growth and strengthen leaf surfaces against pests and powdery mildew. The foliar spray is best applied in the early morning or at night to avoid harsh light.

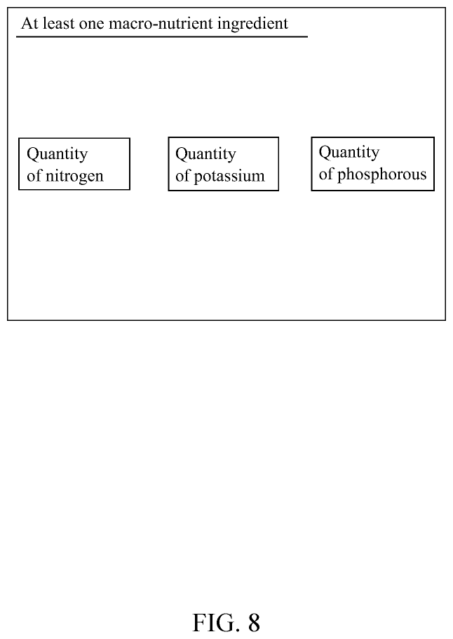

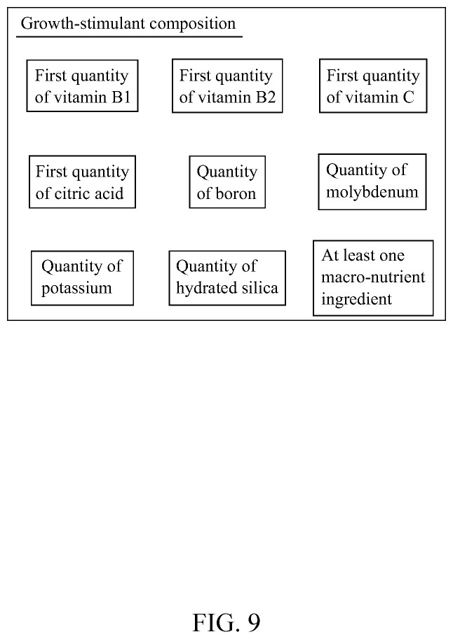

In order to supplement plant nutrition, the present invention may further comprise at least one macro-nutrient ingredient, seen in FIG. 8. The at least one macro-nutrient ingredient is heterogeneously mixed into the growth-stimulant composition, seen in FIG. 9. The at least one macro-nutrient ingredient is preferably a group consisting of a quantity of nitrogen, a quantity of potassium, a quantity of phosphorous, and combinations thereof. The quantity of nitrogen supplements the health of a plant, while the plant is developing and once the plant is harvested. The quantity of potassium aids the resistance of plants against disease. The quantity of phosphorous aids the ability of a plant to use and store energy. More specifically, the at least one macro-nutrient is approximately between 0.5 to 20 wt. % of the growth-stimulant composition.

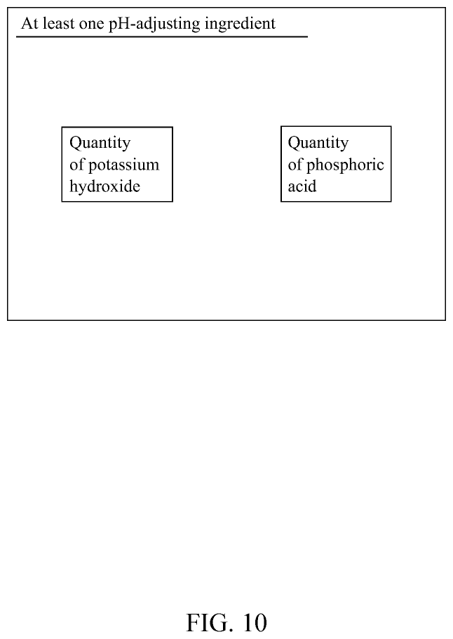

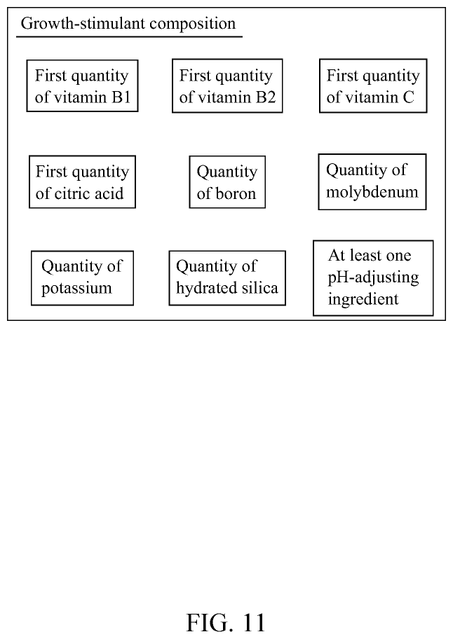

In order to increase nutrient absorption, the present invention may further comprise at least one pH-adjusting ingredient, seen in FIG. 10. The at least one pH-adjusting ingredient is heterogeneously mixed into the growth-stimulant composition, seen in FIG. 11. The at least one pH-adjusting ingredient is preferably a group consisting of a quantity of potassium hydroxide, a quantity of phosphoric acid, and combinations thereof. More specifically, the at least one pH-adjusting ingredient is configured to adjust a pH level of the growth-stimulant composition between 5.6 to 6.4.

The preferred method of manufacturing utilizes a micro-emulsion process in order to create submicron-sized droplets. The method begins by pouring 500 grams of the quantity of water into a three-neck flask. Then, turn on a propylene glycol coolant of a reflux condenser to return vapor to the three-neck flask. Heat the quantity of water at a temperature of approximately between 80 to 100 degrees Fahrenheit. Agitate the quantity of water with a stirrer, preferably a paddle-like stirrer. In order to eliminate side reactions, supply nitrogen into the three-neck flask at a low pressure of approximately between 5 to 10 pounds per square inch (PSI). In order to produce the quantity of hydrated silica, a quantity of potassium silicate is added slowly to the quantity of water in order to maintain temperature for a specified time range of 15 minutes. The quantity of potassium silicate is preferably 40 grams or 4 wt. % of the growth-stimulant composition. The first quantity of vitamin C and the first quantity of citric acid are then added into the three-neck flask to form a first mixture. A second mixture is formed once the first mixture is then heated to a temperature of 120 degrees Fahrenheit for a time range of 40 minutes, and quantity of hydrated silica is formed. This second mixture is cooled to a temperature of 80 degrees Fahrenheit. The first quantity of vitamin B1 is then added to the second mixture and mixed for a time range of 10 minutes. The first quantity of vitamin B2 is then added and mixed for a time range of 15 minutes. The quantity of molybdenum is then added and mixed for a time range of 15 minutes. Then, the quantity of boron is added and mixed for a time range of 45 minutes for the growth-stimulant composition. The growth-stimulant composition is then filtered through a filter, preferably a 0.1-micron filter. The growth-stimulant composition should be stored at a temperature range of approximately between 50 to 110 degrees Fahrenheit. Furthermore, the growth-stimulant composition is stable for a minimum of 24 months, and with mixing up to 48 months.

In the preferred embodiment of the present invention, the quantity of beeswax extract, the second quantity of vitamin B1, the second quantity of vitamin B2, the second quantity of vitamin C, and the second quantity of citric acid may each be added after the quantity of boron is added and before the growth-stimulant composition is mixed for a time range of 45 minutes. The at least one macro-nutrient ingredient may then be added after the growth-stimulant composition is filtered, followed by the addition of the at least one pH-adjusting ingredient as needed.

Although the invention has been explained in relation to its preferred embodiment, it is to be understood that many other possible modifications and variations can be made without departing from the spirit and scope of the invention as hereinafter claimed.

What is claimed is:

1. A composition for a plant growth additive comprising:
a first quantity of vitamin B1;
a first quantity of vitamin B2;
a first quantity of vitamin C;
a first quantity of citric acid;
a quantity of boron;
a quantity of molybdenum;
a quantity of potassium;
a quantity of hydrated silica; and,
the first quantity of vitamin B1, the first quantity of vitamin B2, the first quantity of vitamin C, the first quantity of citric acid, the quantity of boron, the quantity of molybdenum, the quantity of potassium, and the quantity of hydrated silica being homogeneously mixed into a growth-stimulant composition.

2. The composition for a plant growth additive as claimed in claim 1, wherein the first quantity of vitamin B1 is approximately between 0.5 to 2 percentage by weight (wt. %) of the growth-stimulant composition.

3. The composition for a plant growth additive as claimed in claim 1, wherein the first quantity of vitamin B2 is approximately between 0.1 to 2 wt. % of the growth-stimulant composition.

4. The composition for a plant growth additive as claimed in claim 1, wherein the first quantity of vitamin C is approximately between 0.5 to 4 wt. % of the growth-stimulant composition.

5. The composition for a plant growth additive as claimed in claim 1, wherein the first quantity of citric acid is approximately between 0.1 to 4 wt. % of the growth-stimulant composition.

6. The composition for a plant growth additive as claimed in claim 1, wherein the quantity of boron is approximately between 0.001 to 0.3 wt. % of the growth-stimulant composition.

7. The composition for a plant growth additive as claimed in claim 1, wherein the quantity of molybdenum is approximately between 0.0001 to 0.02 wt. % of the growth-stimulant composition.

8. The composition for a plant growth additive as claimed in claim 1, wherein the quantity of potassium is approximately between 0.1 to 3 wt. % of the growth-stimulant composition.

9. The composition for a plant growth additive as claimed in claim 1, wherein the quantity of hydrated silica is approximately between 0.2 to 5 wt. % of the growth-stimulant composition.

10. The composition for a plant growth additive as claimed in claim 1:
a quantity of beeswax extract; and,
the quantity of beeswax extract being heterogeneously mixed into the growth-stimulant composition.

11. The composition for a plant growth additive as claimed in claim 10:
the quantity of beeswax extract being approximately between 0.1 to 3 wt. % of the growth-stimulant composition.

12. The composition for a plant growth additive as claimed in claim 1:
a second quantity of vitamin B1; and,
the second quantity of vitamin B1 being heterogeneously mixed into the growth-stimulant composition.

13. The composition for a plant growth additive as claimed in claim 13:
the second quantity of vitamin B1 being approximately between 0.5 to 2 wt. % of the growth-stimulant composition.

14. The composition for a plant growth additive as claimed in claim 1:
a second quantity of vitamin B2; and,
the second quantity of vitamin B2 being heterogeneously mixed into the growth-stimulant composition.

15. The composition for a plant growth additive as claimed in claim 14:
the second quantity of vitamin B2 being approximately between 0.1 to 1 wt. % of the growth-stimulant composition.

16. The composition for a plant growth additive as claimed in claim 1:
a second quantity of vitamin C; and,
the second quantity of vitamin C being heterogeneously mixed into the growth-stimulant composition.

17. The composition for a plant growth additive as claimed in claim 17:
the second quantity of vitamin C being approximately between 0.227 to 4 wt. % of the growth-stimulant composition.

18. The composition for a plant growth additive as claimed in claim 1:
a second quantity of citric acid; and,
the second quantity of citric acid being heterogeneously mixed into the growth-stimulant composition.

19. The composition for a plant growth additive as claimed in claim 18:
the second quantity of citric acid being approximately between 0.2 to 5 wt. % of the growth-stimulant composition.

20. The composition for a plant growth additive as claimed in claim 1, wherein a nutrient solution comprises a quantity of solute and a quantity of solvent, and wherein the quantity of solute is the growth-stimulant composition, and wherein the quantity of solvent is a quantity of water.

21. The composition for a plant growth additive as claimed in claim 20, wherein the quantity of solute is approximately between 0.26 to 0.79 wt. % of the quantity of nutrient solution.

22. The composition for a plant growth additive as claimed in claim 20, wherein the quantity of solute is approximately between 0.79 to 4 wt. % of the quantity of nutrient solution.

23. The composition for a plant growth additive as claimed in claim 20, wherein the quantity of solute is approximately between 2.6 to 5.3 wt. % of the quantity of nutrient solution.

24. The composition for a plant growth additive as claimed in claim 1:
at least one macro-nutrient ingredient; and,
the at least one macro-nutrient ingredient being heterogeneously mixed into the growth-stimulant composition.

25. The composition for a plant growth additive as claimed in claim 24 wherein the at least one macro-nutrient ingredient is a group consisting of: a quantity of nitrogen, a quantity of potassium, a quantity of phosphorous, and a combination thereof.

26. The composition for a plant growth additive as claimed in claim 24, wherein the at least one macro-nutrient ingredient is approximately between 0.5 to 20 wt. % of the growth-stimulant composition.

27. The composition for a plant growth additive as claimed in claim 1:
at least one pH-adjusting ingredient; and,
the at least one pH-adjusting ingredient being heterogeneously mixed into the growth-stimulant composition.

28. The composition for a plant growth additive as claimed in claim 27, wherein the at least one pH-adjusting ingredient is a group consisting of: a quantity of potassium hydroxide, a quantity of phosphoric acid, and combinations thereof.

29. The composition for a plant growth additive as claimed in claim 27, wherein the at least one pH-adjusting ingredient is configured to adjust a pH level of the growth-stimulant composition between 5.6 to 6.4.
